(19) United States
(12) Patent Application Publication
(10) Pub. No.: US 2025/0315989 A1
(43) Pub. Date: Oct. 9, 2025

(54) Method for Training Image Generation Model, Method for Generating Digital Human Image, Electronic Device and Storage Medium

(71) Applicant: Beijing Baidu Netcom Science Technology Co., Ltd., Beijing (CN)

(72) Inventors: Xuesong Wang, Beijing (CN); Rui Yang, Beijing (CN); Xiaodong Zhang, Beijing (CN)

(21) Appl. No.: 19/242,543

(22) Filed: Jun. 18, 2025

(30) Foreign Application Priority Data
Mar. 18, 2025 (CN) 202510323752.X

(51) Int. Cl. G06T 11/00; G06V 10/20; G06V 10/74; G06V 10/774; G06V 40/16

(52) U.S. Cl. CPC G06T 11/00; G06V 10/20; G06V 10/761; G06V 10/774; G06V 40/171

(57) ABSTRACT

A method for training an image generation model, a method for generating a digital human image, and related apparatuses are provided, relating to the fields of artificial intelligence, big model, big data and other technologies. The method for training an image generation model includes: obtaining N target facial images of a target face, wherein N is an integer greater than 1; inputting the N target facial images and at least one target background image into a preset image generation model to obtain a target digital human image after the target face is fused with each target background image; and training the preset image generation model based on a degree of difference between a first facial feature in the target digital human image and a second facial feature of the target face in the target facial images to obtain a target image generation model.

### CROSS-REFERENCE TO RELATED APPLICATIONS

The present application claims priority to Chinese Patent Application No. CN202510323752.X, filed with the China National Intellectual Property Administration on Mar. 18, 2025, the disclosure of which is hereby incorporated herein by reference in its entirety.

### TECHNICAL FIELD

The present disclosure relates to the field of image processing technology, and in particular to the fields of artificial intelligence, big model, big data and other technologies.

### BACKGROUND

With the rapid advancement of Artificial Intelligence Generated Content (AIGC) technology and the growing demand for digital human image generation, open-source platforms have played a core role in promoting innovation in this field. However, in the field of digital human image generation, current technologies cannot accurately capture facial details, affecting the quality and authenticity of image generation.

### SUMMARY

The present disclosure provides a method for training an image generation model, and a method and an apparatus for generating a digital human image.

According to one aspect of the present disclosure, provided is a method for training an image generation model, including:
obtaining N target facial images of a target face, where N is an integer greater than 1;
inputting the N target facial images and at least one target background image into a preset image generation model to obtain a target digital human image after the target face is fused with each target background image; and
training the preset image generation model based on a degree of difference between a first facial feature in the target digital human image and a second facial feature of the target face in the target facial images to obtain a target image generation model.

According to another aspect of the present disclosure, provided is a method for generating a digital human image, including:
obtaining a plurality of facial images to be processed for a preset face; and
inputting the plurality of facial images to be processed and at least one preset background image into a target image generation model to obtain a digital human image after the preset face is fused with each preset background image;
where the target image generation model is obtained by training a preset image generation model based on a degree of difference between a first facial feature in a target digital human image and a second facial feature of a target face in a target facial image; the target digital human image is obtained by inputting at least N target facial images into the preset image generation model; the N target facial images are obtained by expanding M initial facial images; N is an integer greater than 1; and M is a natural number less than N.

According to another aspect of the present disclosure, provided is an apparatus for training an image generation model, including:
an image expansion unit configured to obtain N target facial images of a target face, where N is an integer greater than 1;
a first generation unit configured to input the N target facial images and at least one target background image into a preset image generation model to obtain a target digital human image after the target face is fused with each target background image; and
a training unit configured to train the preset image generation model based on a degree of difference between a first facial feature in the target digital human image and a second facial feature of the target face in the target facial images to obtain a target image generation model.

According to another aspect of the present disclosure, provided is an apparatus for generating a digital human image, including:
an image obtaining unit configured to obtain a plurality of facial images to be processed for a preset face; and
a second generation unit configured to input the plurality of facial images to be processed and at least one preset background image into a target image generation model to obtain a digital human image after the preset face is fused with each preset background image;
where the target image generation model is obtained by training a preset image generation model based on a degree of difference between a first facial feature in a target digital human image and a second facial feature of a target face in a target facial image; the target digital human image is obtained by inputting at least N target facial images into the preset image generation model; the N target facial images are obtained by expanding M initial facial images; N is an integer greater than 1; and M is a natural number less than N.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

The solution of the present disclosure can use multiple images with the same face to provide facial details under different conditions for the preset image generation model, and obtain the target digital human image output by the preset image generation model, and then use the difference between the target digital human image output by the preset image generation model and the output image to perform model training on the preset image generation model, so that the generalization ability of the preset image generation model in the training process is enhanced while the facial consistency and style stability of the generated target digital human image are also effectively improved, thereby laying a foundation for improving the user experience.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a first schematic flowchart of a method for training an image generation model according to an embodiment of the present application.

FIG. 2 is a second schematic flowchart of a method for training an image generation model according to an embodiment of the present application.

FIG. 3(a) is a first schematic diagram of generating a target digital human image according to an embodiment of the present application.

FIG. 3(b) is a second schematic diagram of generating a target digital human image according to an embodiment of the present application.

FIG. 4 is a third schematic flowchart of a method for training an image generation model according to an embodiment of the present application.

FIG. 5 is a schematic diagram of image expansion using initial facial images according to an embodiment of the present application.

FIG. 6 is a schematic flowchart of a method for generating a digital human image according to an embodiment of the present application.

FIG. 7 is a first structural schematic diagram of an apparatus 700 for training an image generation model according to an embodiment of the present disclosure.

FIG. 8 is a second structural schematic diagram of an apparatus 700 for training an image generation model according to an embodiment of the present disclosure.

FIG. 9 is a structural schematic diagram of an apparatus 900 for generating a digital human image according to an embodiment of the present disclosure.

FIG. 10 shows a schematic block diagram of an exemplary electronic device 1000 that may be used to implement the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

The related technologies of the embodiments of the present disclosure will be illustrated below. The following related technologies are optional solutions that can be arbitrarily combined with the technical solutions of the embodiments of the present disclosure, and all belong to the protection scope of the embodiments of the present disclosure.

With the vigorous development of the AIGC technology, the application of open-source platforms in the field of digital human image generation is becoming more and more extensive, becoming an important force in promoting innovation in this field. By using the open-source platforms, realistic and creative digital human images can be generated, and even complex face-swapping operations can be performed to thereby meet the growing demand for personalization.

Although the AIGC technology has made significant progress in digital human image generation, it still faces some technical bottlenecks. For example, current face-swapping or consistency generation techniques mainly rely on a single input image, for example, a single input image is used for model training or image generation. This method suffers from the problem of insufficient sampling and cannot fully capture all the details and features of the face. Moreover, due to insufficient sampling, when attempting to generate digital human images or swap faces, the system often finds it difficult to accurately simulate facial details of persons in different environments. This results in inconsistency in the generated images in terms of facial feature, expression, etc., thereby affecting the quality and authenticity of the final output image and seriously reducing the user experience.

Based on this, the solution of the present disclosure provides a method for training an image generation model and a method for generating a digital human image using the trained image generation model. The training method in the solution of the present disclosure can improve the quality and quantity of target facial images effectively and thus improve the facial consistency and style stability of the target digital human image based on the consistency fusion technology of multiple target facial images combined with feature changes and dataset expansion strategies. Specifically, the training method in the solution of the present disclosure can improve the quality and quantity of target facial images in combination with feature changes and dataset expansion strategies. Moreover, the training method can also perform consistency fusion on multiple expanded target facial images, thereby effectively improving the facial consistency and style stability of the generated target digital human image.

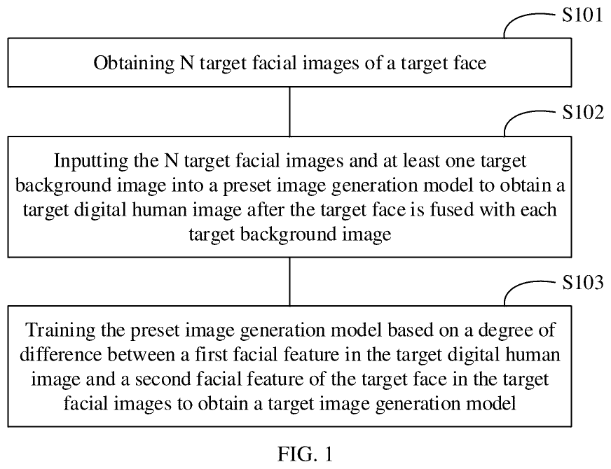

Specifically, FIG. 1 is a first schematic flowchart of a method for training an image generation model according to an embodiment of the present application. This method is optionally applied in electronic devices, such as personal computers, servers, server clusters and other electronic devices.

Further, this method includes at least a part of the following content. As shown in FIG. 1, this method includes:

Step S101: obtaining N target facial images of a target face.

Here, N is an integer greater than 1. For example, the N target facial images are N facial images containing the same face in one example.

Step S102: inputting the N target facial images and at least one target background image into a preset image generation model to obtain a target digital human image after the target face is fused with each target background image.

That is to say, in one example, a plurality of target facial images of the same target face and a plurality of target background images may be simultaneously input into the preset image generation model to thereby obtain the target digital human image after the target face is fused with each target background image. It can be understood that, in this example, the number of generated target digital human images is the same as the number of input target background images, thus providing strong support for implementing facial changes in batches.

Here, in one example, the target background images may include but are not limited to indoor environment, natural scenery, propaganda poster, etc. In practical applications, the target background images may be determined according to specific requirements of digital human image generation, and are not specifically limited in the solution of the present disclosure.

Step S103: training the preset image generation model based on a degree of difference between a first facial feature in the target digital human image and a second facial feature of the target face in the target facial images to obtain a target image generation model.

In this way, the solution of the present disclosure can use multiple images with the same face (for example, images with different details of the same face) to provide facial details under different conditions for the preset image generation model, and obtain the target digital human image output by the preset image generation model, and then use the difference between the target digital human image output by the preset image generation model and the output image (that is, the target facial image) to perform model training on the preset image generation model, so that the generalization ability of the preset image generation model in the training process is enhanced while the facial consistency and style stability of the generated target digital human image are also effectively improved, thereby laying a foundation for improving the user experience.

Further, in a specific example, different target facial images have different image features.

Further, in one example, the image features may include but are not limited to at least one of: angle, light, or facial details, etc.

For instance, in one example, different target facial images are located at different angles (for example, front, side or half-side, etc.).

Optionally, in another example, different target facial images have different light environments. Optionally, in yet another example, different target facial images have different facial details (for example, facial texture or expression, etc.).

In this way, since different target facial images have different image features, more abundant and diverse training samples can be constructed, thereby effectively improving the generalization ability of the target image generation model obtained after training, and also providing data support for improving the facial consistency and style stability of the generated target digital human image.

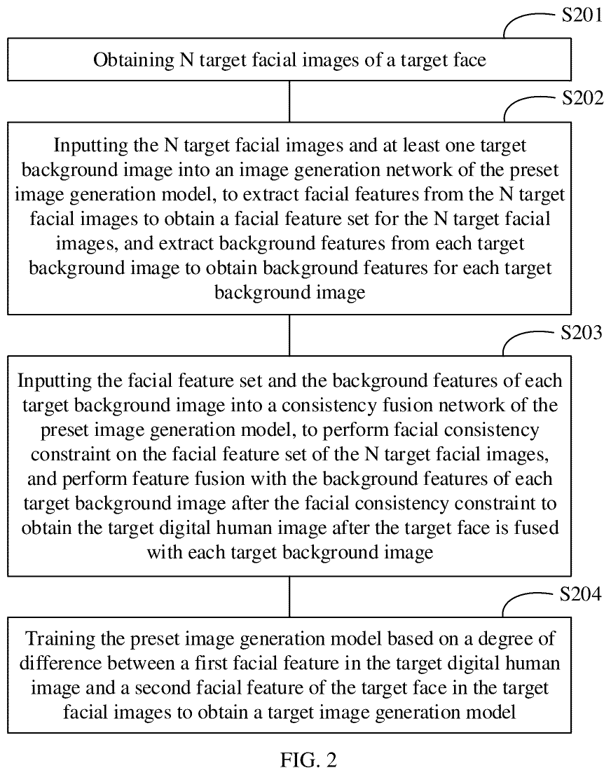

FIG. 2 is a second schematic flowchart of a method for training an image generation model according to an embodiment of the present application. This method is optionally applied in electronic devices, such as personal computers, servers, server clusters and other electronic devices. It can be understood that the relevant content of the method shown in FIG. 1 described above may also be applied to this example, and the relevant content will not be repeated in this example.

Further, this method includes at least a part of the following content. As shown in FIG. 2, this method includes:

Step S201: obtaining N target facial images of a target face.

Here, N is an integer greater than 1.

It should be noted that, for relevant examples of the target facial images, reference may be made to the above description, which will not be repeated here.

Step S202: inputting the N target facial images and at least one target background image into an image generation network of the preset image generation model, to extract facial features from the N target facial images to obtain a facial feature set for the N target facial images, and extract background features from each target background image to obtain background features for each target background image.

That is to say, the preset image generation model includes the image generation network in this example. For example, the image generation network may be specifically a stable diffusion network in one example.

Further, the image generation network may be used to extract facial features from each input target facial image. Here, the facial features may include five sense organs, facial contour, facial texture and other details in one example.

Further, a set containing facial features of each target facial image, namely a facial feature set, can be obtained after the image generation network is used to extract facial features from each target facial image.

Further, the image generation network may also be used to extract background features from each input target background image. Here, the background features may include color, texture, shape, and other information helping to describe the overall style and details of the background image in one example.

Step S203: inputting the facial feature set and the background features of each target background image into a consistency fusion network of the preset image generation model, to perform facial consistency constraint on the facial feature set of the N target facial images, and perform feature fusion with the background features of each target background image after the facial consistency constraint to obtain the target digital human image after the target face is fused with each target background image.

That is to say, the preset image generation model may also include the consistency fusion network in this example. At this time, the consistency fusion network may be used to perform facial consistency constraint on the facial feature set containing facial features of the N target facial images, aiming to ensure that the final generated target digital human image can accurately reflect these facial features. In other words, the consistency fusion network can make the facial features in the final generated target digital human image tend to be consistent (for example, highly consistent in structure, style and details) with those in the target facial image, thereby improving the facial consistency and style stability.

Here, the consistency fusion network may be used to perform consistency constraint on the facial feature set containing facial features of the N target facial images in one example. Further, the consistency fusion network may also be used to fuse the consistency constraint result of the facial feature set (i.e., the facial features after consistency constraint) with the background features of each target background image, to thereby obtain the target digital human image after the target face is fused with each target background image.

Alternatively, the preset image generation model may also include an image fusion module in another example. In this example, the consistency fusion network is used to output the consistency constraint result of the facial feature set. Further, the image fusion module is used to fuse the consistency constraint result of the facial feature set with the background features of each target background image, to thereby obtain the target digital human image after the target face is fused with each target background image.

Here, it should be noted that the preset image generation model may also include other necessary modules such as a decoder according to actual reasoning requirements. The image fusion module included in the preset image generation model mentioned above is only exemplary, and the solution of the present disclosure does not limit whether other modules are additionally included in the preset image generation model.

Here, it should be noted that the target background image may specifically include a facial area. For example, the target background image may specifically be a related image including a face and background where the face is located, such as a poster image, etc. At this time, in this scenario, the facial features after consistency fusion may be specifically fused into the facial area of the background features in the process of fusing the facial features (for example, the facial features after consistency fusion) with the background features, thus achieving replacement or adjustment of facial features.

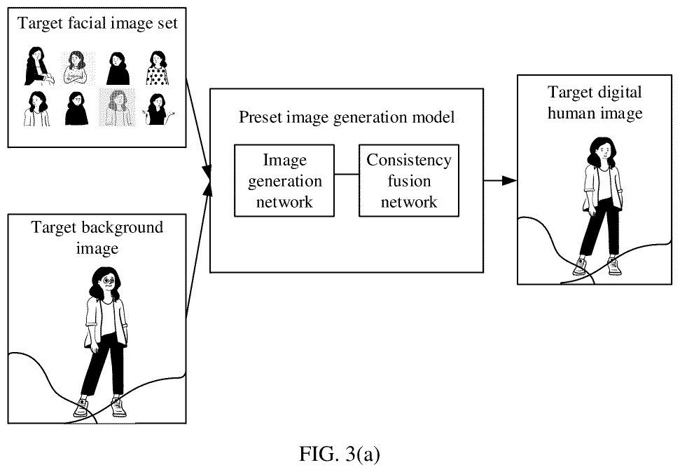

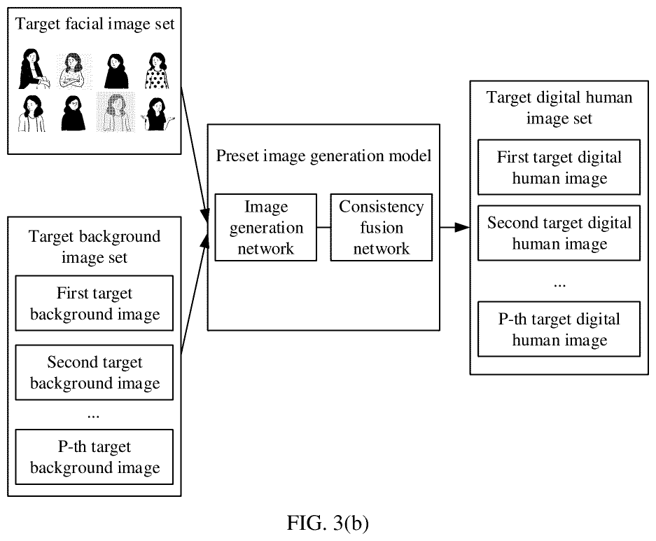

FIG. 3(a) is a first schematic diagram of generating a target digital human image according to an embodiment of the present application. In one example, as shown in FIG. 3(a), a target facial image set (including N target facial images) and a target background image are input into a preset image generation model. Here, the preset image generation model may include an image generation network and a consistency fusion network. Further, the image generation network is used to extract features from the target facial image set to obtain a facial feature set corresponding to the target facial image set, and the image generation network is used to extract background features from the target background image to obtain background features.

Further, in one example, the background features may include facial position information, so as to accurately locate the replacement position corresponding to the face-swapping operation.

Further, the facial feature set is input into the consistency fusion network to perform facial consistency constraint on the facial feature set. Finally, the target digital human image is obtained after feature fusion of the consistency constraint result of the facial feature set with the background features of the target background image.

FIG. 3(b) is a second schematic diagram of generating a target digital human image according to an embodiment of the present application. In one example, as shown in FIG. 3(b), a target facial image set (including N target facial images) and a target background image set (for example, including P target background images, respectively denoted as: the first target background image, the second target background image, . . . , the P-th target background image; where P is an integer greater than or equal to 2) are input into a preset image generation model.

Here, the preset image generation model may include an image generation network and a consistency fusion network. Further, the image generation network is used to extract features from the target facial image set to obtain a facial feature set corresponding to the target facial image set, and the image generation network is used to extract background features from each target background image in the target background image set to obtain background features of each target background image.

Further, in one example, the background features of each target background image may include facial position information, so as to accurately locate the replacement position corresponding to the face-swapping operation.

Further, the facial feature set is input into the consistency fusion network to perform facial consistency constraint on the facial feature set. Finally, a target digital human image set is obtained after feature fusion of the consistency constraint result of the facial feature set with the background features of each target background image. The target digital human image set includes a total of P target digital human images after the target face is fused with each target background image, for example, respectively denoted as the first target digital human image, the second target digital human image, . . . , the P-th target digital human image.

It should be noted that, for relevant examples of how to generate the target digital human image based on the consistency constraint result of the facial feature set and the background features, reference may be made to the above description, which will not be repeated here.

Moreover, in some examples, in order to clarify the position, posture and interaction details with the surrounding environment of the digital human in the image, the preset prompt information may also be input into the preset image generation model along with the target facial image set and the target background image, so as to use the input prompt information to guide the preset image generation model to generate the target digital human image meeting requirements.

Step S204: training the preset image generation model based on a degree of difference between a first facial feature in the target digital human image and a second facial feature of the target face in the target facial images to obtain a target image generation model.

That is to say, after the target digital human image is generated using the preset image generation model, the degree of difference between the first facial feature in the target digital human image and the second facial feature of the target face in each target facial image may be used as a reference factor for model training, so as to obtain the target image generation model when the degree of difference between the facial features in the target digital human image and the facial features of the target face in each target facial image meets the preset requirement or when the training reaches the training termination condition.

It should be noted that the solution of the present disclosure can also adopt a multi-stage training strategy to enhance the ability of the model to restore facial consistency in different environments.

In this way, the solution of the present disclosure can use the image generation network to extract facial features from a plurality of target facial images, and use the consistency fusion network to perform consistency constraint on the facial features corresponding to the plurality of target facial images, so that the generated target digital human image maintains consistency with the input target facial image in terms of facial features, thereby improving the generation quality of the target digital human image.

In addition, since the solution of the present disclosure introduces the plurality of target facial images for the same target face, it is convenient to describe the features of the target face from multiple dimensions through the plurality of target facial images. For example, the features of the target face may be described from facial angle, light condition, facial details and other aspects. Therefore, the problem of large deviation between the generated digital human image and the input facial image due to insufficient facial features can be solved, so that the generated digital human image is significantly improved in detail expression and overall visual effect.

At the same time, compared with the traditional AIGC generation technology, the solution of the present disclosure can enable the preset image generation model to learn more abundant and diverse information based on the features of the target face, thereby enhancing the stability of the generation result.

In other words, the target image generation model obtained after training by the solution of the present disclosure can not only improve the accuracy in generating digital human images, but also has strong applicability. For example, the high-quality visual generation effects can be maintained under different platforms, devices and application scenarios.

Further, in a specific example, the preset image generation model may be trained in the following manner; and specifically, the above-mentioned step of training the preset image generation model based on a degree of difference between a first facial feature in the target digital human image and a second facial feature of the target face in the target facial images (for example, step S204) may specifically include:

Step S204-1: calculating at least similarity between the first facial feature in the target digital human image and the second facial feature of the target face in each target facial image to obtain similarity information.

Here, a facial comparison algorithm, such as Learned Perceptual Image Patch Similarity (LPIPS) and Frechet Inception Distance (FID), may be used to calculate the similarity between the first facial feature in the target digital human image and the second facial feature in each target facial image, so as to obtain the similarity information between the first facial feature in the target digital human image and the second facial feature in each target facial image based on the similarity calculation result.

Step S204-2: fine-tuning an image generation parameter in the preset image generation model based on the similarity information.

For example, a total of N similarity values are calculated between the first facial feature in the target digital human image and the second facial feature in each target facial image. Further, if a total of P target digital human images are generated, a total of N×P similarity values are obtained. At this time, the N×P similarity values may be directly used to fine-tune the image generation parameter in the preset image generation model.

Here, it should be noted that the image generation parameter may be an adjustable parameter that controls the output result of the preset image generation model. For example, the image generation parameter may include the weight of the neural network in the model, a bias item, etc., or may include a parameter affecting the consistency of the generated target digital human image.

Further, the image generation parameter is fine-tuned on the basis of the preset image generation model according to the similarity information obtained above, to improve the output quality of the preset image generation model.

In this way, the output image and the difference between facial features in the output image can be accurately quantified by calculating the similarity of facial features between the target digital human image and each target facial image, thus providing an accurate direction for subsequently fine-tuning the preset image generation model. Moreover, fine-tuning of the preset image generation model based on the similarity information can improve the output quality of the model in a targeted manner, thereby improving the generation quality of the target digital human image, so that the generated target digital human image maintains consistency with the input target facial image in terms of facial features.

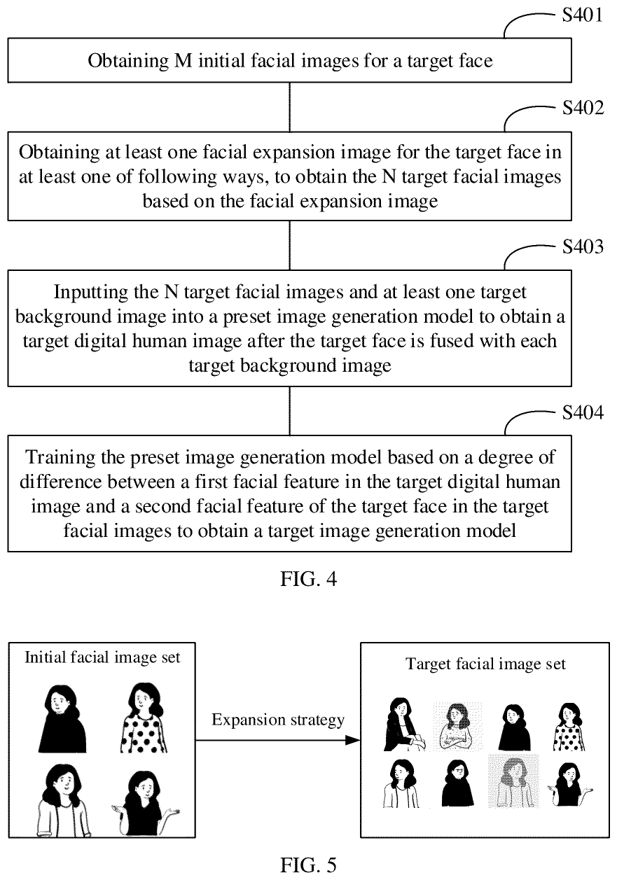

Specifically, FIG. 4 is a third schematic flowchart of a method for training an image generation model according to an embodiment of the present application. This method is optionally applied in electronic devices, such as personal computers, servers, server clusters and other electronic devices. It can be understood that the relevant content of the method shown in FIGS. 1 to 3 described above may also be applied to this example, and the relevant content will not be repeated in this example.

Further, this method includes at least a part of the following content. As shown in FIG. 4, this method includes:

Step S401: obtaining M initial facial images for a target face.

Here, M is a natural number less than or equal to N, and N is an integer greater than 1.

In an example, the M initial facial images may be facial images of the same target person from different angles, under different light conditions or with different facial details. At this time, in this example, N target facial images may be obtained by expansion based on facial images with different angles, light conditions or facial details, so it is convenient for the model to describe the features of the target face from multiple dimensions through the target facial images. For example, the features of the target face may be described from facial angle, light condition, facial details and other aspects, thus providing strong support for solving the problem of large deviation between the generated digital human image and the input facial image due to insufficient facial features.

Alternatively, the M initial facial images may be M identical images in another example. At this time, in this example, the feature random change or expansion strategy provided in the solution of the present disclosure may be used to perform feature expansion, thus also providing strong support for solving the problem of large deviation between the generated digital human image and the input facial image due to insufficient facial features.

Step S402: obtaining at least one facial expansion image for the target face in at least one of following ways (i.e., at least one of three ways), to obtain the N target facial images based on the facial expansion image.

It should be noted that, for relevant examples of the target facial images, reference may be made to the above description, which will not be repeated here.

Further, in the first way, the target face is locally perturbed based on facial key features of the initial facial images. In other words, in the first way, the feature expansion may be performed by locally perturbing (for example, randomly perturbing) the target face to obtain a new facial image.

It should be noted that the new facial image obtained after the feature expansion may be collectively referred to as a facial expansion image in this example. Further, the facial expansion image may be used as a target facial image, thereby achieving the expansion of the training dataset.

Further, in a specific example, the target face may be locally perturbed in the following manner; and specifically, the above-mentioned step of locally perturbing the target face based on facial key features of the initial facial images may specifically include: fine-tuning non-key points (e.g., non-five sense organs, etc.) in the target face for local perturbation based on the facial key features of the initial facial images. In other words, the local perturbation (for example, making random or specific small changes) can keep key facial features unchanged and fine-tune other details, thereby improving the data diversity.

Here, in one example, the non-key points of the initial facial images may include facial contour, skin texture, expression and action, and other detailed information, which is not specifically limited in the solution of the present disclosure.

In this way, since the solution of the present disclosure fine-tunes the non-key points of the initial facial images, the details of the initial facial images can be enriched without changing the overall facial structure, thereby effectively improving the data diversity, and also providing strong support for improving the generalization ability of model learning and thus improving the output quality of the model.

In the second way, a viewing angle of the target face is fine-tuned based on facial key features of the initial facial images. In other words, in the second way, the viewing angle of the target face may be fine-tuned, for example, randomly adjusted, to obtain a new facial image, thereby simulating facial changes under different viewing angles and effectively improving the data diversity.

Further, in a specific example, the viewing angle of the target face may be fine-tuned in the following manner; and specifically, the above-mentioned step of fine-tuning the viewing angle of the target face based on facial key features of the initial facial images may specifically include: fine-tuning the facial key features of the initial facial images based on the target face at a preset viewing angle, to fine-tune the viewing angle of the target face.

Here, in this example, the preset viewing angle can be understood as the viewing angle that the target face is expected to achieve, and for example, may be a specific angle such as front, side, elevation angle or depression angle, etc., which is not limited in the solution of the present disclosure and may be set based on actual generation requirements.

Here, in one example, in order to enable the target face to be presented at the preset viewing angle, the manner to fine-tune the facial key features may include moving, rotating, scaling, etc. the facial key features.

In this way, the solution of the present disclosure can generate facial images at different viewing angles, increasing the diversity of facial images and thus facilitating the preset image generation model to obtain facial features from the target facial images at different viewing angles, and also providing strong support for improving the generalization ability of model learning and thus improving the output quality of the model.

In the third way, the light environment of the target face is transformed based on facial key features of the initial facial images. In other words, in the third way, the light environment of the target face may be fine-tuned, for example, randomly adjusted, to obtain a new facial image, thereby simulating facial changes under different light conditions and effectively improving the data diversity.

Further, in a specific example, the light environment of the target face may be transformed in the following manner; and specifically, the above-mentioned step of transforming the light environment of the target face based on facial key features of the initial facial images may specifically include: fine-tuning the facial key features of the initial facial images based on a preset light condition, to transform the light environment of the target face.

Here, in one example, the preset light condition may be one or more specific light conditions that have been set, such as the position, intensity, color and other parameters of the light source, thus facilitating the simulation of different natural light or artificial light environments to adapt the target face to different light environments.

For example, the manner to fine-tune the facial key features may include changing the brightness, contrast, etc. of the facial area to simulate the effect of the preset light condition on the facial features in one example.

In this way, the solution of the present disclosure can simulate facial images with different lighting effects, increasing the diversity of facial images and thus facilitating the preset image generation model to obtain facial features from the target facial images at different viewing angles, and also providing strong support for improving the generalization ability of model learning and thus improving the output quality of the model.

FIG. 5 is a schematic diagram of image expansion using initial facial images according to an embodiment of the present application. As shown in FIG. 5, an initial facial image set includes M initial facial images, and the M initial facial images are expanded based on an expansion strategy (for example, including at least one of local perturbation, fine-tuning of viewing angle, or transformation of light condition) to obtain a target facial image set (including N target facial images).

It should be noted that, in the process of expanding the M initial facial images, a specified expansion strategy (such as one of the three ways above) may be selected, or one or two of the three expansion strategies may be randomly selected, or the three expansion strategies may be directly used, or the like. The solution of the present disclosure does not limit the specific selection method of the expansion strategy.

It should be noted that the number M of initial facial images and the number N of target facial images in FIG. 5 are only exemplary. In practical applications, M may be less than or equal to N, and is not limited in the solution of the present disclosure.

Step S403: inputting the N target facial images and at least one target background image into a preset image generation model to obtain a target digital human image after the target face is fused with each target background image.

It should be noted that, for relevant examples of generating the target digital human image, reference may be made to the above description, which will not be repeated here.

Step S404: training the preset image generation model based on a degree of difference between a first facial feature in the target digital human image and a second facial feature of the target face in the target facial images to obtain a target image generation model.

It should be noted that, for relevant examples of training the preset image generation model, reference may be made to the above description, which will not be repeated here.

In this way, the solution of the present disclosure can use the initial facial images to generate the same or greater number of target facial images (N, where N is greater than or equal to M), thus increasing the diversity and richness of the facial image dataset, helping the preset image generation model to fully understand facial features, thereby improving the generalization ability of model training, and making the generated digital human image more realistic.

Moreover, compared with the method for generating the digital human image based on the diffusion model or generative adversarial network, the solution of the present disclosure can obtain the target facial images under multiple viewing angles, different facial details or different light environments, and optimize the preset image generation model based on the target facial images, thereby enhancing the robustness and adaptability of the model in practical applications.

Further, in a specific example, since the N target facial images are determined based on the facial expansion images and the facial expansion images are determined based on the facial key features of the initial facial images, in order to accurately obtain the facial key features of the initial facial images, the method further includes:
preprocessing the initial facial images;
performing feature encoding on preprocessed initial facial images; and
performing feature extraction on key points in feature-encoded initial facial images to obtain the facial key features of the initial facial images.

Here, before the initial facial images are used for subsequent processing, a series of preset operations or transformations, namely, preprocessing, may be performed on the initial facial images. These preprocessing steps can improve image quality, enhance image features, reduce noise or interference, etc.

Specifically, in one example, the step of preprocessing the initial facial images may include:
(1) Noise removal: reducing noise in the initial facial images through a filter or other means to improve the image quality;
(2) Image normalization: adjusting the pixel value ranges of the images to conform to a specific distribution or range; and
(3) Image alignment: locating the facial areas in the initial facial images, and performing operations such as rotation or scaling to keep the facial features in the same position and scale.

It should be noted that the above preprocessing steps are only exemplary, and the solution of the present disclosure does not impose any specific limitation on the image preprocessing flow and method.

Further, based on the preprocessed initial facial images, a feature extraction model (such as Contrastive Language-Image Pre-training (CLIP) model, deep learning network for face recognition (such as face network FaceNet), etc.) may be used to convert the facial features in the initial facial images into numerical expressions to complete feature encoding. Further, the feature extraction is performed on key points in the feature-encoded initial facial images, so as to obtain the facial key features of the initial facial images.

In this way, the solution of the present disclosure can effectively improve the quality of the initial facial images by preprocessing the initial facial images, making the subsequent feature encoding and feature extraction more accurate and reliable.

Moreover, the high-dimensional initial facial images can be converted into low-dimensional feature data through feature encoding, thereby enhancing the expression ability of the features of the initial facial images.

In addition, the feature extraction further performed on the key points based on feature encoding of the initial facial images can accurately obtain the facial key features of the initial facial images, providing a data basis for subsequently obtaining the N target facial images.

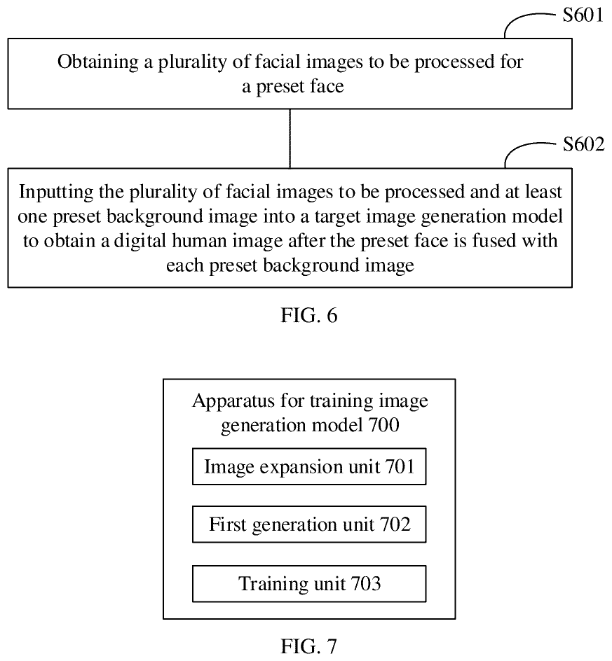

The solution of the present disclosure further provides a method for generating a digital human image. Specifically, FIG. 6 is a schematic flowchart of the method for generating the digital human image according to an embodiment of the present application. This method is optionally applied in electronic devices, such as personal computers, servers, server clusters and other electronic devices.

Further, this method includes at least a part of the following content. As shown in FIG. 6, this method includes:

Step S601: obtaining a plurality of facial images to be processed for a preset face.

It should be noted that the examples related to the facial images to be processed are similar to the examples related to the target facial images, and reference may be made to the above description of the target facial images, which will not be repeated here.

Step S602: inputting the plurality of facial images to be processed and at least one preset background image into a target image generation model to obtain a digital human image after the preset face is fused with each preset background image.

Here, the target image generation model is obtained by training a preset image generation model based on a degree of difference between a first facial feature in a target digital human image and a second facial feature of a target face in a target facial image, and the target digital human image is obtained by inputting at least N target facial images into the preset image generation model.

Further, the N target facial images are obtained by expanding M initial facial images, where N is an integer greater than 1; and M is a natural number less than or equal to N.

Further, in one example, the target image generation model is obtained by using the training method described above.

In one example, the plurality of facial images to be processed for the preset face and a plurality of preset background images may be simultaneously input into the target image generation model, to thereby obtain the digital human image after the preset face is fused with each preset background image. It can be understood that, in this example, the number of generated digital human images is the same as the number of input preset background images, so that batch facial changes can be achieved, thereby improving the efficiency of batch facial changes of digital humans.

It should be noted that, for relevant examples of the target digital human image, the preset image generation model, the target facial image and the initial facial image, reference may be made to the above description, which will not be repeated here.

In this way, the solution of the present disclosure can utilize the target image generation model to generate the digital human image based on the plurality of facial images to be processed for the preset face, and the digital human image has facial consistency and style stability with the input facial images to be processed, thereby improving the user experience effectively.

Furthermore, a plurality of target facial images are used in the process of training the target image generation model, so the target image generation model can accurately extract facial features in these images, effectively alleviating the problem of low image generation quality caused by insufficient sampling; and moreover, the target image generation model can maintain the style consistency of the generated digital human image, thereby effectively preventing the occurrence of style drift phenomenon.

In addition, the target image generation model proposed in the solution of the present disclosure is highly scalable and can be integrated into various AIGC generation frameworks such as stable diffusion.

Based on the above advantages, the target image generation model in the solution of the present disclosure can be applied to a variety of scenarios. For example, the target image generation model in the solution of the present disclosure can improve the consistency of character image in the field of digital human production; the target image generation model in the solution of the present disclosure can ensure the continuity of face-swapping effect during live broadcast in the field of virtual anchor; the target image generation model in the solution of the present disclosure can efficiently generate high-quality character images and speed up the post-production process in the field of film and television production; and the target image generation model in the solution of the present disclosure can enable users to maintain consistent avatar styles on different platforms in the field of social media avatar generation.

The solution of the present disclosure further provides an apparatus 700 for training an image generation model, as shown in FIG. 7, including:
an image expansion unit 701 configured to obtain N target facial images of a target face, where N is an integer greater than 1;
a first generation unit 702 configured to input the N target facial images and at least one target background image into a preset image generation model to obtain a target digital human image after the target face is fused with each target background image; and
a training unit 703 configured to train the preset image generation model based on a degree of difference between a first facial feature in the target digital human image and a second facial feature of the target face in the target facial images to obtain a target image generation model.

In a specific example of the solution of the present disclosure, the image expansion unit 701 is specifically configured to:
obtain M initial facial images of the target face, where M is a natural number less than or equal to N; and
obtain at least one facial expansion image for the target face in at least one of following ways, to obtain the N target facial images based on the facial expansion image:
perturbing the target face locally based on facial key features of the initial facial images;
fine-tuning a viewing angle of the target face based on facial key features of the initial facial images; or
transforming light environment of the target face based on facial key features of the initial facial images.

In a specific example of the solution of the present disclosure, the image expansion unit 701 is specifically configured to:
fine-tune non-key points in the target face for local perturbation based on the facial key features of the initial facial images.

In a specific example of the solution of the present disclosure, the image expansion unit 701 is specifically configured to:
fine-tune the facial key features of the initial facial images based on the target face at a preset viewing angle, to fine-tune the viewing angle of the target face.

In a specific example of the solution of the present disclosure, the image expansion unit 701 is specifically configured to:
fine-tune the facial key features of the initial facial images based on a preset light condition, to transform the light environment of the target face.

In a specific example of the solution of the present disclosure, different target facial images have different image features.

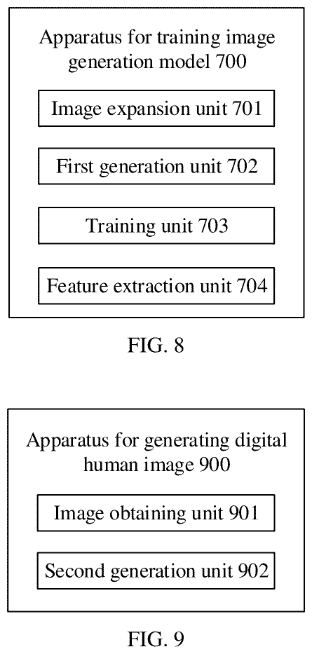

In a specific example of the solution of the present disclosure, as shown in FIG. 8, the apparatus 700 for training the image generation model may further include a feature extraction unit 704, where the feature extraction unit 704 is configured to:
preprocess the initial facial images;
perform feature encoding on preprocessed initial facial images; and
perform feature extraction on key points in feature-encoded initial facial images to obtain the facial key features of the initial facial images.

In a specific example of the solution of the present disclosure, the first generation unit 702 is specifically configured to:
input the N target facial images and at least one target background image into an image generation network of the preset image generation model, to extract facial features from the N target facial images to obtain a facial feature set for the N target facial images, and extract background features from each target background image to obtain background features for each target background image; and
input the facial feature set and the background features of each target background image into a consistency fusion network of the preset image generation model, to perform facial consistency constraint on the facial feature set of the N target facial images, and perform feature fusion with the background features of each target background image after the facial consistency constraint to obtain the target digital human image after the target face is fused with each target background image.

In a specific example of the solution of the present disclosure, the training unit 703 is specifically configured to:
calculate at least similarity between the first facial feature in the target digital human image and the second facial feature of the target face in each target facial image to obtain similarity information; and
fine-tune an image generation parameter in the preset image generation model based on the similarity information.

For the description of specific functions and examples of the units of the apparatus of the embodiment of the present disclosure, reference may be made to the relevant description of the corresponding steps in the above-mentioned method embodiments, and details are not repeated here.

The solution of the present disclosure further provides an apparatus 900 for generating a digital human image, as shown in FIG. 9, including:
an image obtaining unit 901 configured to obtain a plurality of facial images to be processed for a preset face; and
a second generation unit 902 configured to input the plurality of facial images to be processed and at least one preset background image into a target image generation model to obtain a digital human image after the preset face is fused with each preset background image;
where the target image generation model is obtained by training a preset image generation model based on a degree of difference between a first facial feature in a target digital human image and a second facial feature of a target face in a target facial image; the target digital human image is obtained by inputting at least N target facial images into the preset image generation model; the N target facial images are obtained by expanding M initial facial images; N is an integer greater than 1; and M is a natural number less than or equal to N.

For the description of specific functions and examples of the units of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

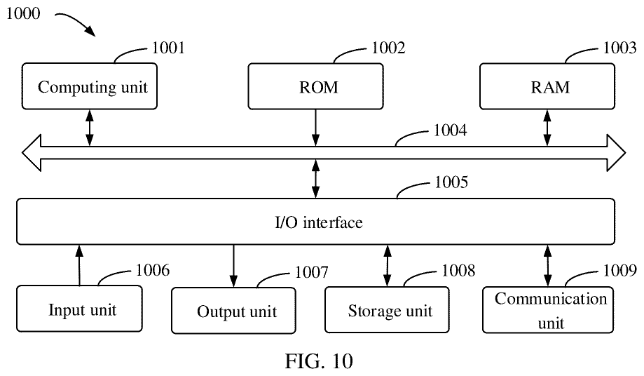

FIG. 10 shows a schematic block diagram of an exemplary electronic device 1000 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 10, the device 1000 includes a computing unit 1001 that may perform various appropriate actions and processes according to a computer program stored in a Read-Only Memory (ROM) 1002 or a computer program loaded from a storage unit 1008 into a Random Access Memory (RAM) 1003. Various programs and data required for an operation of device 1000 may also be stored in the RAM 1003. The computing unit 1001, the ROM 1002 and the RAM 1003 are connected to each other through a bus 1004. The input/output (I/O) interface 1005 is also connected to the bus 1004.

A plurality of components in the device 1000 are connected to the I/O interface 1005, and include an input unit 1006 such as a keyboard, a mouse, or the like; an output unit 1007 such as various types of displays, speakers, or the like; the storage unit 1008 such as a magnetic disk, an optical disk, or the like; and a communication unit 1009 such as a network card, a modem, a wireless communication transceiver, or the like. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1001 performs various methods and processing described above, such as the method for training the image generation model or the method for generating the digital human image. For example, in some implementations, the method for training the image generation model or the method for generating the digital human image may be implemented as a computer software program tangibly contained in a computer-readable medium, such as the storage unit 1008. In some implementations, a part or all of the computer program may be loaded and/or installed on the device 1000 via the ROM 1002 and/or the communication unit 1009. When the computer program is loaded into the RAM 1003 and executed by the computing unit 1001, one or more steps of the method for training the image generation model or the method for generating the digital human image described above may be performed. Alternatively, in other implementations, the computing unit 1001 may be configured to perform the method for training the image generation model or the method for generating the digital human image by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for training an image generation model, comprising:
obtaining N target facial images of a target face, wherein N is an integer greater than 1;
inputting the N target facial images and at least one target background image into a preset image generation model to obtain a target digital human image after the target face is fused with each target background image; and
training the preset image generation model based on a degree of difference between a first facial feature in the target digital human image and a second facial feature of the target face in the target facial images to obtain a target image generation model.

2. The method of claim 1, wherein obtaining the N target facial images of the target face, comprises:
obtaining M initial facial images of the target face, wherein M is a natural number less than or equal to N; and
obtaining at least one facial expansion image for the target face in at least one of following ways, to obtain the N target facial images based on the facial expansion image:
perturbing the target face locally based on facial key features of the initial facial images;
fine-tuning a viewing angle of the target face based on facial key features of the initial facial images; or
transforming light environment of the target face based on facial key features of the initial facial images.

3. The method of claim 2, wherein perturbing the target face locally based on the facial key features of the initial facial images, comprises:
fine-tuning non-key points in the target face for local perturbation based on the facial key features of the initial facial images.

4. The method of claim 2, wherein fine-tuning the viewing angle of the target face based on the facial key features of the initial facial images, comprises:
fine-tuning the facial key features of the initial facial images based on the target face at a preset viewing angle, to fine-tune the viewing angle of the target face.

5. The method of claim 2, wherein transforming the light environment of the target face based on the facial key features of the initial facial images, comprises:
fine-tuning the facial key features of the initial facial images based on a preset light condition, to transform the light environment of the target face.

6. The method of claim 2, wherein different target facial images have different image features.

7. The method of claim 2, further comprising:
preprocessing the initial facial images;
performing feature encoding on preprocessed initial facial images; and
performing feature extraction on key points in feature-encoded initial facial images to obtain the facial key features of the initial facial images.

8. The method of claim 2, wherein inputting the N target facial images and the at least one target background image into the preset image generation model to obtain the target digital human image after the target face is fused with each target background image, comprises:
inputting the N target facial images and at least one target background image into an image generation network of the preset image generation model, to extract facial features from the N target facial images to obtain a facial feature set for the N target facial images, and extract background features from each target background image to obtain background features for each target background image; and
inputting the facial feature set and the background features of each target background image into a consistency fusion network of the preset image generation model, to perform facial consistency constraint on the facial feature set of the N target facial images, and perform feature fusion with the background features of each target background image after the facial consistency constraint to obtain the target digital human image after the target face is fused with each target background image.

9. The method of claim 8, wherein training the preset image generation model based on the degree of difference between the first facial feature in the target digital human image and the second facial feature of the target face in the target facial images, comprises:
calculating at least similarity between the first facial feature in the target digital human image and the second facial feature of the target face in each target facial image to obtain similarity information; and
fine-tuning an image generation parameter in the preset image generation model based on the similarity information.

10. A method for generating a digital human image, comprising:
obtaining a plurality of facial images to be processed for a preset face; and
inputting the plurality of facial images to be processed and at least one preset background image into a target image generation model to obtain a digital human image after the preset face is fused with each preset background image;
wherein the target image generation model is obtained by training a preset image generation model based on a degree of difference between a first facial feature in a target digital human image and a second facial feature of a target face in a target facial image; the target digital human image is obtained by inputting at least N target facial images into the preset image generation model; the N target facial images are obtained by expanding M initial facial images; N is an integer greater than 1; and M is a natural number less than or equal to N.

11. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining N target facial images of a target face, wherein N is an integer greater than 1;
inputting the N target facial images and at least one target background image into a preset image generation model to obtain a target digital human image after the target face is fused with each target background image; and
training the preset image generation model based on a degree of difference between a first facial feature in the target digital human image and a second facial feature of the target face in the target facial images to obtain a target image generation model.

12. The electronic device of claim 11, wherein the instruction, when executed by the at least one processor, enables the at least one processor to execute obtaining the N target facial images of the target face, by:
obtaining M initial facial images of the target face, wherein M is a natural number less than or equal to N; and
obtaining at least one facial expansion image for the target face in at least one of following ways, to obtain the N target facial images based on the facial expansion image:
perturbing the target face locally based on facial key features of the initial facial images;
fine-tuning a viewing angle of the target face based on facial key features of the initial facial images; or
transforming light environment of the target face based on facial key features of the initial facial images.

13. The electronic device of claim 12, wherein the instruction, when executed by the at least one processor, enables the at least one processor to execute perturbing the target face locally based on the facial key features of the initial facial images, by:
fine-tuning non-key points in the target face for local perturbation based on the facial key features of the initial facial images.

14. The electronic device of claim 12, wherein the instruction, when executed by the at least one processor, enables the at least one processor to execute fine-tuning the viewing angle of the target face based on the facial key features of the initial facial images, by:
fine-tuning the facial key features of the initial facial images based on the target face at a preset viewing angle, to fine-tune the viewing angle of the target face.

15. The electronic device of claim 12, wherein the instruction, when executed by the at least one processor, enables the at least one processor to execute transforming the light environment of the target face based on the facial key features of the initial facial images, by:
fine-tuning the facial key features of the initial facial images based on a preset light condition, to transform the light environment of the target face.

16. The electronic device of claim 12, wherein different target facial images have different image features.

17. The electronic device of claim 12, wherein the instruction, when executed by the at least one processor, enables the at least one processor to further execute:
preprocessing the initial facial images;
performing feature encoding on preprocessed initial facial images; and
performing feature extraction on key points in feature-encoded initial facial images to obtain the facial key features of the initial facial images.

18. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 10.

19. A non-transitory computer-readable storage medium storing a computer instruction thereon, wherein the computer instruction is used to cause a computer to execute the method of claim 1.

20. A non-transitory computer-readable storage medium storing a computer instruction thereon, wherein the computer instruction is used to cause a computer to execute the method of claim 10.
